(19) United States
(12) Patent Application Publication
(10) Pub. No.: US 2017/0234978 A1
(43) Pub. Date: Aug. 17, 2017

(54) ENHANCED LOCATION SYSTEM USING WIRELESS TRANSMISSION BEACONS WITH VARYING POWER

(71) Applicant: NextNav, LLC, Sunnyvale, CA (US)

(72) Inventors: WILLIAM M. SHVODIAN, McLean, VA (US); CRISTINA SEIBERT, Mountain View, CA (US)

(21) Appl. No.: 15/584,254

(22) Filed: May 2, 2017

Related U.S. Application Data
(60) Provisional application No. 62/395,753, filed on Sep. 16, 2016.

(51) Int. Cl. G01S 11/06; H04W 28/02; H04B 7/185; G01S 5/14; H04B 7/216; G01S 1/08; G01S 5/02; H04W 52/04; H04B 7/204

(52) U.S. Cl. CPC G01S 11/06; H04W 52/04; H04W 28/0221; H04B 7/18539; H04B 7/2041; H04B 7/216; G01S 1/08; H04B 7/18513; G01S 5/02; G01S 5/14; H04W 4/023

(57) ABSTRACT

Communicating transmission power information that specifies a transmission power used by a reference point for use in estimating a position of a mobile device. Systems and methods measure an amount of power present in a signal received from the reference point, receive an identifier of the reference point and transmission power information that specifies the transmission power used by the reference point, transmit the identifier of the reference point to a location server, and also transmit the transmission power information or an estimate of a distance separating the mobile device and the reference point to the location server.

### RELATED APPLICATIONS

This application relates to the following related application(s): U.S. Pat. Appl. No. 62/395,753, filed Sep. 16, 2016, entitled ENHANCED LOCATION SYSTEM USING WIRELESS TRANSMISSION BEACONS WITH VARYING POWER. The content of each of the related application(s) is hereby incorporated by reference herein in its entirety.

### BACKGROUND

Reference points likes Bluetooth beacons and Wi-Fi access points can be used to estimate the unknown position of a mobile device that is enabled to receive and process signals from such reference points. At least two approaches may be used to estimate the unknown position of the mobile device. In both of these two approaches, each of a plurality of reference points transmits its identifier (e.g., a MAC address) in a signal that is received by the mobile device, and the mobile device measures the signal strength of each signal received from the reference points—e.g., measures a received signal strength indicator (MST) of each signal. The mobile device transmits the measured signal strength of each received signal and the identifier of each reference point to the location server, which uses the measured signal strengths and the identifiers to estimate the unknown position of the mobile device.

In a first approach, the location server identifies a particular signal that had the highest measured signal strength, and concludes that the closest reference point relative to the unknown position of mobile device is a particular reference point from which the particular signal originated. The location server uses the identifier of this particular reference point to look up position information (e.g., a civic address, position coordinates) for the particular reference point. The position information may then be used as the estimate of the unknown position of the mobile device.

In a second approach, the mobile device provides the location server with three or more estimated signal strengths for three corresponding signals received by the mobile device from three or more corresponding reference points. The location server is further provided with the identifiers for each of the reference points. The location server uses the estimated signal strengths along with a standard transmission power used by each of the reference points to estimate corresponding distances between the unknown position of the mobile device and each of the reference points. As an example, each of the estimated distances may be computed using Equation 1 below, applicable to free space environments and assuming isotropic antenna:

d=c×\sqrt{P−S}/4×π×ƒ (Equation 1),

where d is the estimated distance (e.g., in meters), c is the speed of light (in meters/sec), P is the standard transmission power used by each of the reference points (in linear terms—e.g., measured at one meter), S is the measured signal strength (in linear terms), and ƒ is the signal frequency (in hertz). Other equations may be used depending on the environment of deployment. The location server also uses the identifiers to look up position information for each of the reference points, and then uses the estimated distances and the position information during the well-known process of trilateration to estimate the unknown position of the mobile device.

One problem with the above approaches is that the transmission power used by certain reference points (e.g., Bluetooth Low Energy beacons, and Wi-Fi access points) is not a standard transmission power used by all of those reference points. Instead the transmission power can vary across different reference points. For example, the transmission power used by different Bluetooth Low Energy beacons can vary by 30 dB, from 0.01 mW (−20 dBm) to 10 mW (10 dBm). In some cases, the transmission power can vary also vary over different times of signal transmission for a particular reference point, as is sometimes the case with a Wi-Fi access point.

In order to estimate the unknown position of the mobile device using signals from reference points that use different transmission powers, each transmission power used by each reference point must be known in addition to the measured signal strength of each signal. Without knowledge of the transmission power used by each particular reference point, no conclusion can be made that the closest reference point relative to the unknown position of mobile device is a reference point that originated a signal that resulted in the highest measured signal strength. The reasoning is that the closest reference point may be using a lower transmission power than another reference point that is farther away such that the measured signal strength corresponding to a signal from the closest reference point is lower than the measured signal strength corresponding to a signal from the other reference point that is farther away. Also, distances between an unknown position of the mobile device and corresponding reference points cannot be estimated using Equation 1 without knowledge of the transmission power used by each particular reference point.

Thus, the location server cannot accurately determine the location of the mobile device with only the identifier and the measured signal strength. Even where each reference point transmits information that specified the transmission power used by that reference point, and where the mobile device receives that transmission power information, the mobile device is unable to transmit that transmission power information using certain protocols. Thus, improvements are needed to allow the mobile device to send transmission power information to the location server so the location server can use the transmission power information when estimating an unknown position of the mobile device.

### BRIEF DESCRIPTION OF THE DRAWINGS

FIG. 1 depicts an operational environment for communicating a measured RSSI of a signal received by a mobile device from a reference point for use by a location server in computing an estimated position of the mobile device.

FIG. 2 provides a process for communicating a measured RSSI of a signal received by a mobile device from a reference point for use by a location server in computing an estimated position of the mobile device.

FIG. 3 provides an operational environment for using transmission power information of a reference point in connection with computing an estimated position of a mobile device.

FIG. 4A depicts a process for communicating transmission power information received by a mobile device from a reference point for use by a location server in computing an estimated position of the mobile device.

FIG. 4B depicts another process for communicating transmission power information received by a mobile device from a reference point for use by a location server in computing an estimated position of the mobile device.

FIG. 4C depicts a process for using transmission power information received by a mobile device from a reference point to compute an estimated distance between the mobile device and the reference point, and for communicating the estimated distance for use by a location server in computing an estimated position of the mobile device.

FIG. 5A depicts a process for using transmission power information received by a mobile device from a reference point to modify a measured RSSI of a signal received by the mobile device from the reference point, and for communicating the modified RSSI for use by a location server in computing an estimated position of the mobile device.

FIG. 5B depicts a process for using transmission power information received by a mobile device from a reference point to modify a measured RSSI of a signal received by the mobile device from the reference point, for using the modified RSSI to compute an estimated distance between the mobile device and the reference point, and for communicating the estimated distance to a location server for use in computing an estimated position of the mobile device.

FIG. 6 depicts a process for retrieving stored transmission power information relating to a reference point that transmitted a signal to a mobile device for use by a location server in computing an estimated position of the mobile device.

### DETAILED DESCRIPTION

The following disclosure describes different aspects of systems and methods that are used to estimate a position of a mobile device using one or more signals from one or more reference points.

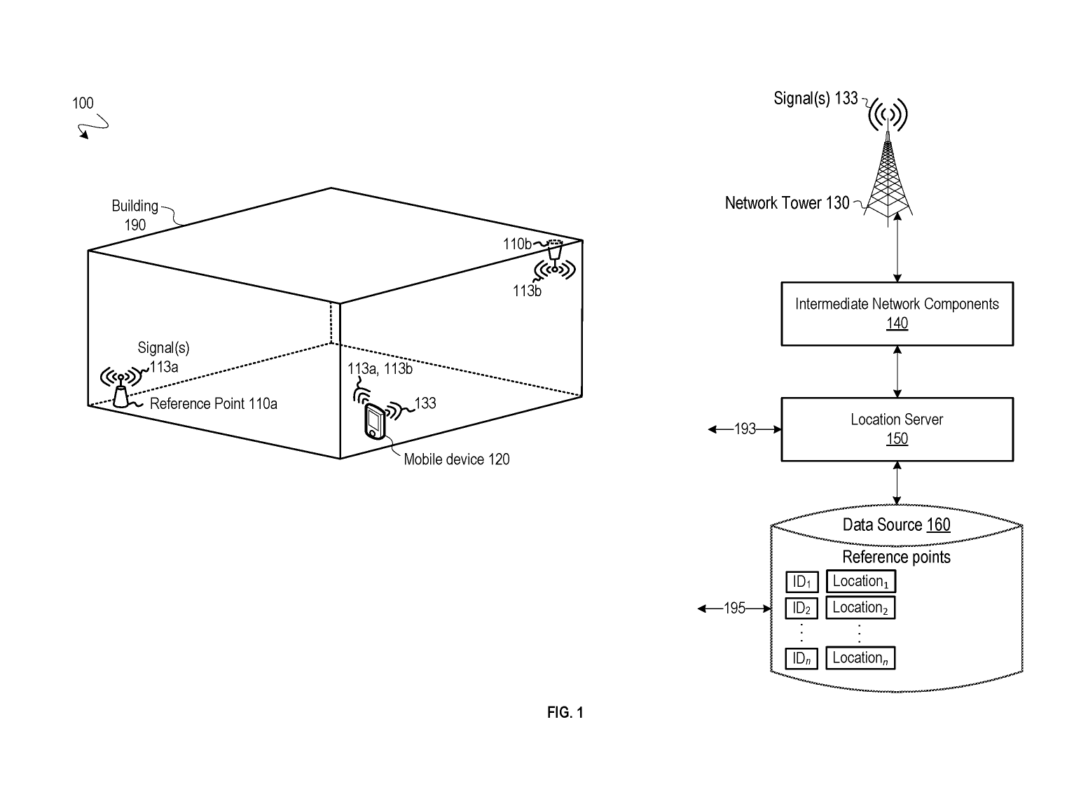

Attention is initially drawn to FIG. 1, which depicts an operational environment 100 for communicating a measured RSSI of a signal received by a mobile device from a reference point for use by a location server in computing an estimated position of the mobile device.

The operational environment 100 includes a mobile device 120, a reference point 110a that transmits a signal 113a that is received by the mobile device 120, and a reference point 110b that transmits a signal 113b that is received by the mobile device 120.

Each of the reference points 110a and 110b may be a Bluetooth beacon (e.g., a Bluetooth Low Energy), a Wi-Fi access point, or another type of transmitter capable of transmitting signals that are received by the mobile device 120 at an unknown position of the mobile device for use in computing an estimate of that unknown position.

Although only two reference points 110a and 110b are shown in FIG. 1, any number of reference points may be used, including only one reference point or more than two reference points. Each of the references points may be members of a network (e.g., a local area network), and may be located within a building 190 or at another area in the operational environment 100. Although only one floor is shown in the building 190, any number of floors is envisioned, as is any number of reference points per floor.

The operational environment 100 also includes a location server 150 that is coupled to a data source 160. The location server 150 is also coupled to the mobile device 120 (e.g., via intermediary components). In some embodiments, the data source 160 may be coupled to the mobile device 120 (e.g., via intermediary components). The mobile device 120 may communicate with the location server 150 using known techniques for doing so—e.g., via a network tower 130 (e.g., of a cellular network) using signaling 133 and via any intermediate network components 140; e.g., via another communication channel 193 (e.g., a local area network, such as a Wi-Fi network). Similar techniques may be used to allow communication between the mobile device 120 and the data source 160, including communication via a communication channel 195.

In one embodiment of FIG. 1, the following components are used: an eNB (base station at the network tower 130); a MME (an intermediate network component 140); an eSMLC (location server 150); and the National Emergency Address Database (NEAD), a database operated by an entity that manages the reference points 110a and/or 110b, or another source of data (data source 160).

The location server 150 is used to compute an estimated position of the mobile device 120. In one implementation of FIG. 1, the reference point 110a transmits its identifier (e.g., a MAC address, or other identifier) in the signal 113a, the mobile device 120 measures a received signal strength indicator (RSSI) of the signal 113a, the mobile device provides the identifier and the measured RSSI to the location server 150, the location server 150 uses the identifier to query the data source 160 for a location of the reference point 110a (e.g., Location₁) that is stored in association with the identifier (e.g., ID₁), and the location server 150 uses the retrieved location and the measured RSSI to compute an estimated position of the mobile device 120.

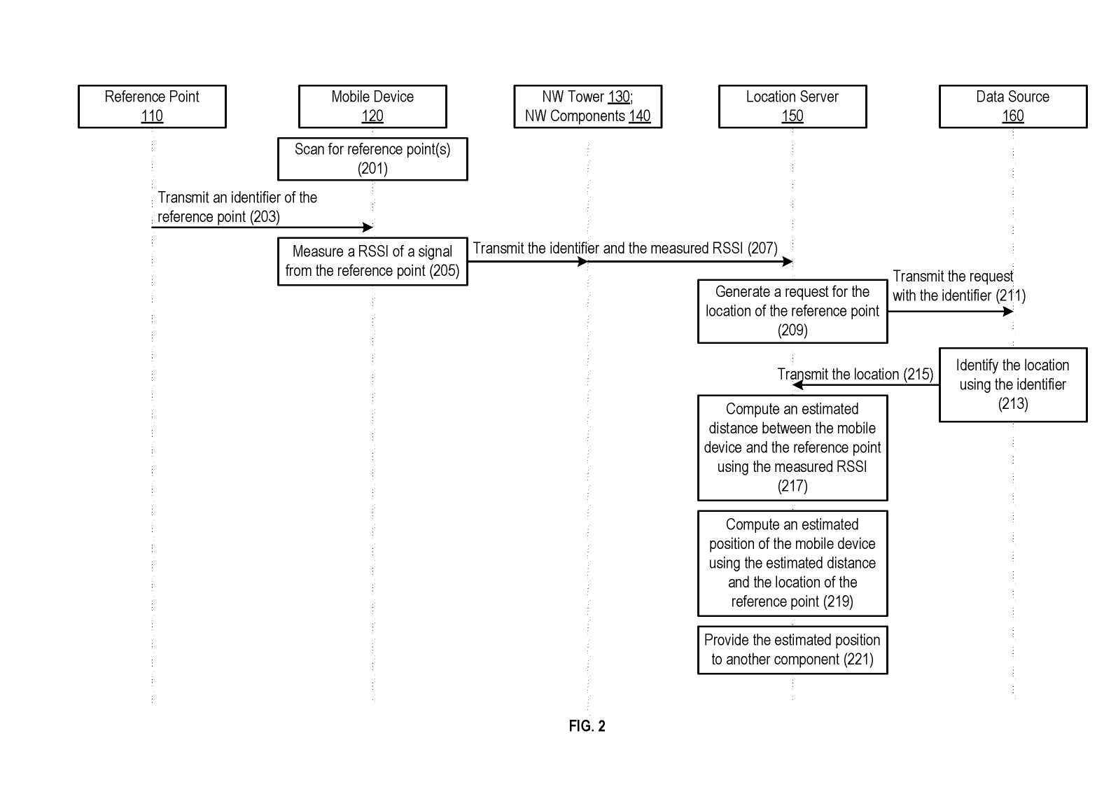

A process for communicating a measured RSSI of a signal received by a mobile device from a reference point for use by a location server in computing an estimated position of the mobile device is depicted in FIG. 2.

The designation of ‘110’ is used below to designate an example reference point, which may include the reference point 110a, the reference point 110b, or another reference point (not shown in FIG. 1). Similarly, the designation of ‘113’ is used below to designate an example signal for an example reference point, which may include the signal 113a, the signal 113b, or another signal (not shown in FIG. 1).

As shown in FIG. 2, the mobile device 120 scans for one or more available reference points (step 201). By way of example, the mobile device 120 may scan for one or more available reference points after a request is made to compute an estimated position of the mobile device 120, as is known in the art.

The mobile device 120 receives an identifier of a reference point 110 from signaling received by the mobile device 120 from the reference point 110 (step 203). Identifiers of reference points are well-known in the art (e.g., MAC addresses, or other identifiers).

The mobile device 120 measures a received signal strength indication (RSSI) of a signal received from the reference point 110 (step 205). Techniques for measuring RSSI are well-known in the art.

The mobile device 120 transmits the identifier of the reference point 110 and the measured RSSI to the location server 150 (step 207). Transmission may occur through a network tower 130 and intermediate network components 140, or through an alternative communication channel 193 from the mobile device 120 to the location server 150.

The location server 150 generates a request for the location of the reference point 110 using known approaches for generating such a request (step 209), and transmits the request with the identifier to the data source 160 using known approaches for transmitting such information (step 211). The data source 160 uses the identifier of the reference point 110 to identify (e.g., look up) a stored location of the reference point 110 that is associated with the identifier (step 213), and transmits the stored location of the reference point 110 to the location server 150 using known approaches for transmitting such information (step 215).

The location server 150 computes an estimated distance between the reference point 110 and an unknown position of the mobile device 120 using the measured RSSI (step 217). By way of example, the estimated distance d may be computed using the previously-presented Equation 1, where P is a standard transmission power used by the reference point 110 and other reference points, and S is the measured RSSI.

The location server 150 uses known techniques (e.g., trilateration) to estimate a position of the mobile device 120 using the estimated distance and the location of the reference point 110 (step 219). After the estimated position is computed, the location server 150 provides the estimated position to the mobile device 120, a Public Safety Access Point (“PSAP”), or other component (step 221).

In some embodiments, the steps prior to step 219 of FIG. 2 may be repeated for additional reference points before the estimated position is computed using corresponding estimated distances between the mobile device 120 and each of the additional reference points. After enough estimated distances are computed during step 217, the well-known technique of trilateration may be used to compute the estimated position of the mobile device 120 during step 219 using those estimated distances and known locations of corresponding reference points 110 (e.g., the stored locations).

Of course, computation of a distance between the reference point 110 and an unknown position of the mobile device 120 is not required to estimate the unknown position of the mobile device 120. Instead, in other embodiments, a proximity algorithm is used by the location server 150 to estimate the unknown position of the mobile device 120. For example, the estimated position may be set to the civic address of the closest reference point relative to the unknown position of the mobile device 120, where the closest reference point is assumed to have transmitted a signal 113 that resulted in the highest measured RSSI. This assumption is possible only where all reference points use a standard transmission power.

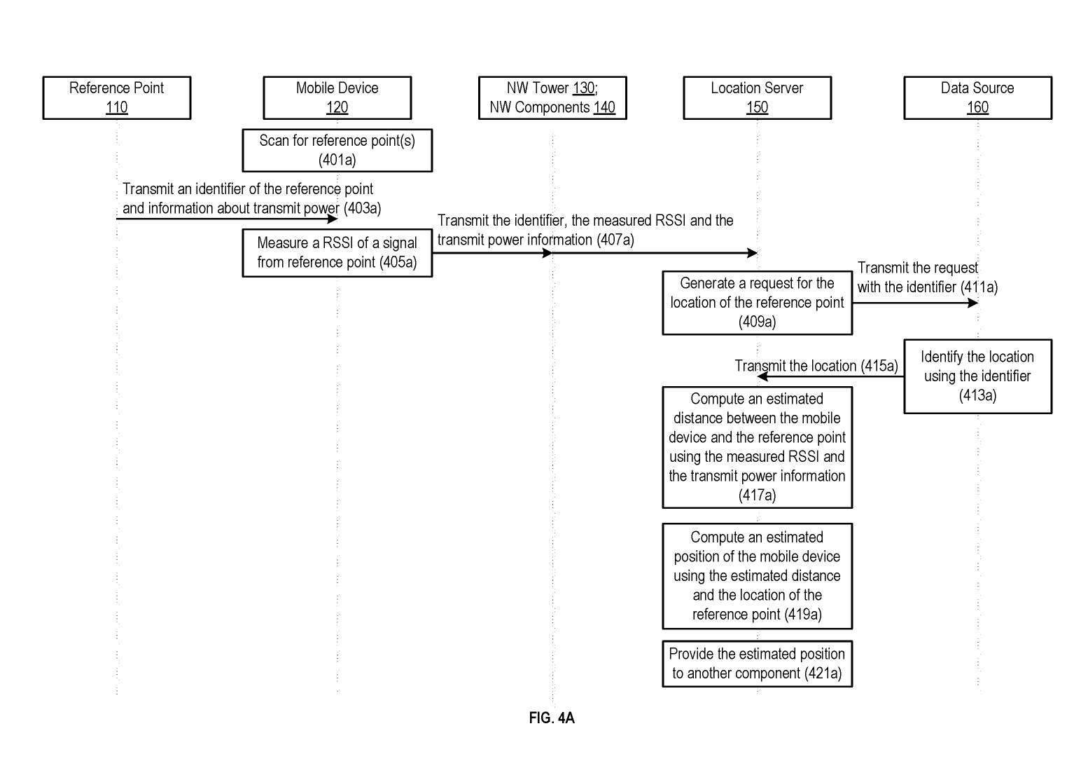

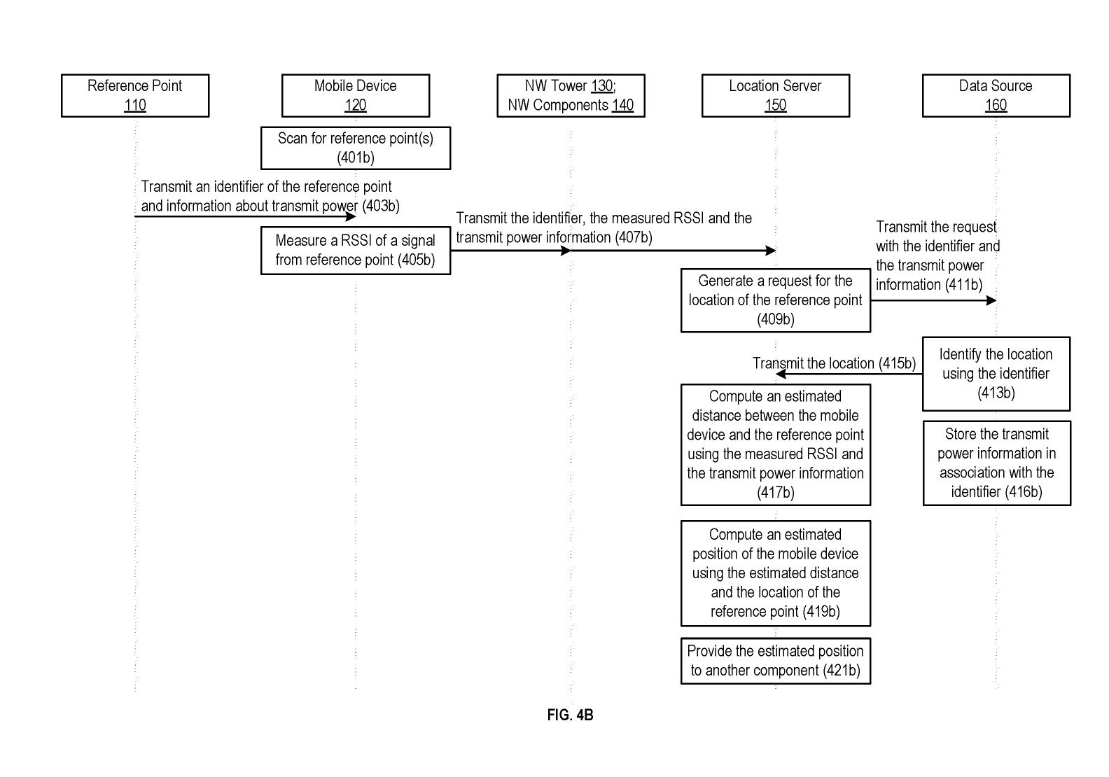

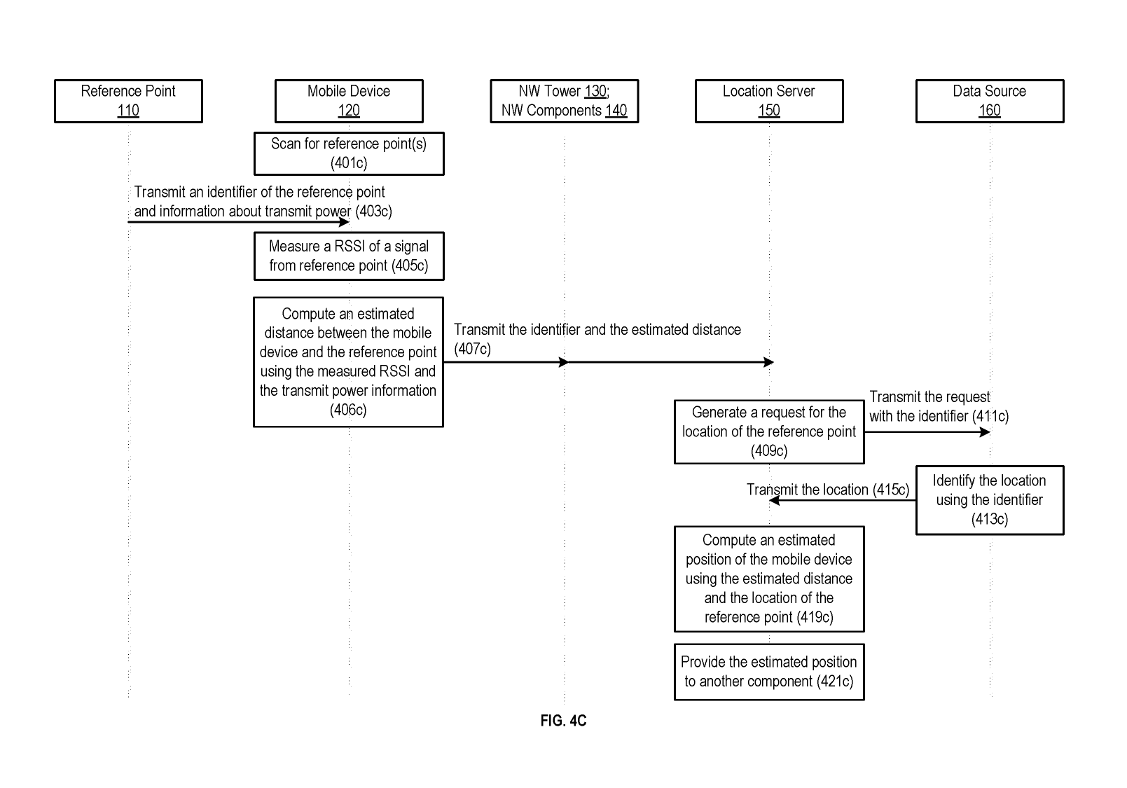

Unfortunately, the location server 150 cannot accurately determine the location of the mobile device 120 with a measured RSSI under circumstances where transmission power varies for different reference points (e.g., different Bluetooth Low Energy beacons, different Wi-Fi access points, or different reference points of another type) and where the location server 150 does not have access to information about a particular transmission power used by a particular reference point. However, certain protocols do not provide transmission power information for a particular reference point 110 to the location server 150 so the location server 150 can estimate the position of the mobile device 120 using the transmission power information. As discussed later with reference to FIG. 4A, the transmission power information of a particular reference point 110 may be received by the mobile device 120 from the reference point 110, and then provided to the location server 150 for use in estimating an unknown position of the mobile device 120. Transmission power information can take various forms, including (1) the actual transmission power level used by a reference point, or a reference power level measured at a known distance from a reference point. In one embodiment, the transmission power information includes a Reference RSSI that was previously measured at a known distance (e.g., 1 meter) from a particular reference point (e.g., a Bluetooth Low Energy beacon). In another embodiment, the transmission power information includes a Transmit Power Used field transmitted by a particular reference point 110 (e.g., a Wi-Fi access point). Such transmit power information is typically transmitted via the signal 113 from the reference point 110, and later received and processed by the mobile device 120 using known means (e.g., an antenna-equipped chip, software for interpreting the received signal 113, and/or other hardware and software known in the art).

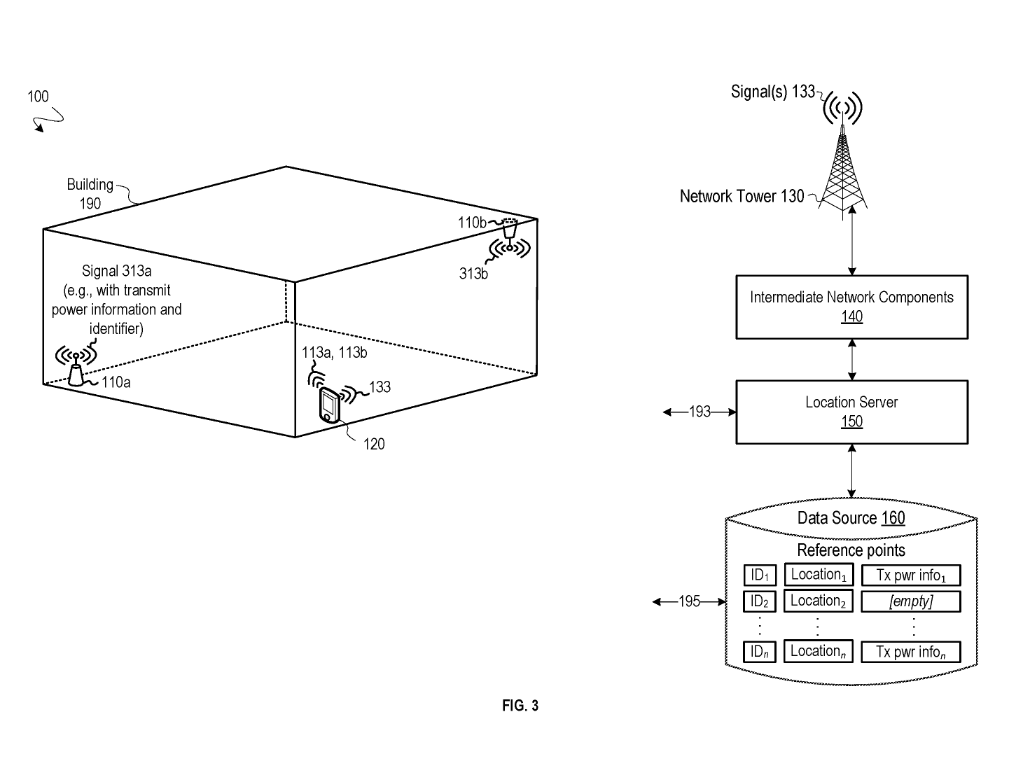

Attention is now drawn FIG. 3, which depicts an operational environment 300 that includes many of the components and features of the operational environment 100 illustrated in FIG. 1, but with a few modifications for using transmission power information of a reference point in connection with computing an estimated position of a mobile device.

As shown, the reference point 110a transmits a signal 313a that includes different data (e.g., transmission power information, and an identifier of the reference point 110a). Transmission of the data may be by way of chips permitted for each type of data. Other signals of other reference points may also include transmission power information and identifiers of those other reference points. The signal 313a is received by the mobile device 120 (e.g., by an antenna-equipped chip of the mobile device), and the data of the signal 313a is decoded if needed before known techniques are used by the mobile device 120 to prepare the data for transmission to the location server 150 (e.g., via the network tower 130 and intermediate network components 140).

Data is communicated from the mobile device 120 to the location server 150 using known protocols (e.g., LPP, LPPe, or another protocol). However, as discussed later, new information elements are needed to transmit particular data from the mobile device 120 to the location server 150. In different embodiments, the particular data includes (i) transmit power information that was received by the mobile device 120 from a reference point 110, (ii) an indication that transmit power information is not being transmitted from the mobile device 120 to the location server 150, (iii) an estimated distance between an unknown position of the mobile device 120 and a reference point 110 that the mobile device 120 computed using transmit power information, (iv) a modified RSSI that the mobile device 120 computed using transmit power information, and/or (v) an indication that a modified RSSI is not being transmitted from the mobile device 120 to the location server 150.

The transmission power information of a reference point can additionally or alternatively be stored in the data source 160 for later access by the location server 150 or the mobile device 120. To do so, the data source 160 is configured to have a field for the transmission power information (“Tx pwr info”) of a reference point, and the transmission power information may be looked up using an identifier (“ID”) of that reference point.

Different processes depicted in FIG. 4A through FIG. 6 use different aspects of the operational environment 300 illustrated in FIG. 3.

A process for communicating transmission power information received by a mobile device from a reference point for use by a location server in computing an estimated position of the mobile device is depicted in FIG. 4A.

As shown in FIG. 4A, the mobile device 120 scans for one or more available reference points (step 401a). The mobile device 120 receives an identifier of a reference point 110 from signaling received by the mobile device 120 from the reference point 110 (step 403a).

The mobile device 120 also receives transmission power information from the reference point 110 (step 403a). By way of example, transmission power information may include a Reference RSSI value from a Bluetooth Low Energy Beacon, a Transmit Power Used value from a Wi-Fi access point (e.g., as described in 8.4.1.20 of IEEE 802.11-2012), or other transmission power information from another type of reference point.

The mobile device 120 measures a RSSI of a signal received from the reference point 110 (step 405a). In other embodiments, other known measures of signal strength such as Received Channel Power Indicator (RCPI) may alternatively be used in place of the measured RSSI.

The mobile device 120 transmits the identifier of the reference point 110, the measured RSSI and the transmission power information to the location server 150 (step 407a). In an alternative embodiment of step 407a, where transmission power information is not received during step 403a or where the mobile device 120 is a legacy mobile device that does not support transmission of the transmission power information to the network, the mobile device 120 transmits an indication that transmission power information is not being transmitted. The indication may take different forms in different embodiments. In one embodiment, the indication is a flag (e.g., one or more bits). In another embodiment, the indication includes fields allocated for the transmission power information that are set to predefined values (e.g., zeros, ones, or other values). In yet another embodiment, the indication (e.g., fields) may not be present.

The location server 150 generates a request for the location of the reference point 110 (step 409a), and transmits the request with the identifier to the data source 160 (step 411a). The data source 160 uses the identifier of the reference point 110 to identify a stored location of the reference point 110 (step 413a), and transmits the stored location of the reference point 110 to the location server 150 (step 415a).

The location server 150 computes an estimated distance between the reference point 110 and an unknown position of the mobile device 120 using the measured RSSI and the transmission power information (step 417a). By way of example, the estimated distance d may be computed using Equation 2 below:

$$d = \frac{c \times \sqrt{P - S}}{4 \times π \times f} , \qquad ( Equation 2 )$$

where P is the transmission power information received from the reference point 110, S is the measured RSSI, and the remaining terms are the same as Equation 1. Other equations may be used depending on the environment of deployment.

The location server 150 uses known techniques to estimate a position of the mobile device 120 using the estimated distance and the location of the reference point 110 (step 419b), and the location server 150 provides the estimated position to the mobile device 120, a Public Safety Access Point (“PSAP”), or other component (step 421a). The approaches for computing an estimated position of the mobile device 120 that were described for step 219 of FIG. 2 may be used during step 419a. In some embodiments, the steps prior to step 419a of FIG. 4A may be repeated for additional reference points before the estimated position is computed using estimated distances between the mobile device 120 and each of the additional reference points.

Of course, computation of a distance between the reference point 110 and an unknown position of the mobile device 120 is not required to estimate the unknown position of the mobile device 120. Instead, in other embodiments, a proximity algorithm is used to estimate the unknown position of the mobile device 120. For example, the estimated position may be set to the civic address of the closest reference point relative to the unknown position of the mobile device 120, where the closest reference point is determined by computing the difference between the measured RSSI and the transmit power information (e.g., the Reference RSSI), and then selecting the reference point with the smallest difference as the closest reference point—e.g., minᵢ(reference RSSIᵢ—measured RSSIᵢ).

The difference between the measured RSSI and the transmit power information can alternatively be used as a weight in combining the coordinates of those reference points (or a subset thereof), if known, to arrive at the coordinates for the mobile device—e.g., weightᵢ=1 /10̂[(reference RSSIᵢ—measured RSSIᵢ)/10].

### Embodiments for Storing Transmission Power Information for Later use in Computing an Estimated Position of a Mobile Device

A process for communicating transmission power information received by a mobile device from a reference point for use by a location server in computing an estimated position of the mobile device is depicted in FIG. 4B.

As shown in FIG. 4B, the mobile device 120 scans for one or more available reference points (step 401b). The mobile device 120 receives an identifier of the reference point 110 from signaling received by the mobile device 120 from the reference point 110 (step 403b). The mobile device 120 also receives transmission power information from the reference point 110 (step 403b), and the mobile device 120 measures a RSSI of a signal received from the reference point 110 (step 405b).

The mobile device 120 transmits the identifier of the reference point 110, the measured RSSI and the transmission power information to the location server 150 (step 407b). Transmission may occur through a network tower 130 and intermediate network components 140, or through an alternative channel from the mobile device 120 to the location server 150.

The location server 150 generates a request for the location of the reference point 110 (step 409b), and transmits the request with the identifier to the data source 160 (step 411b).

The location server 150 also transmits the transmission power information to the data source 160 (step 411b).

The data source 160 uses the identifier of the reference point 110 to identify a stored location of the reference point 110 (step 413b), and transmits the stored location of the reference point 110 to the location server 150 (step 415b).

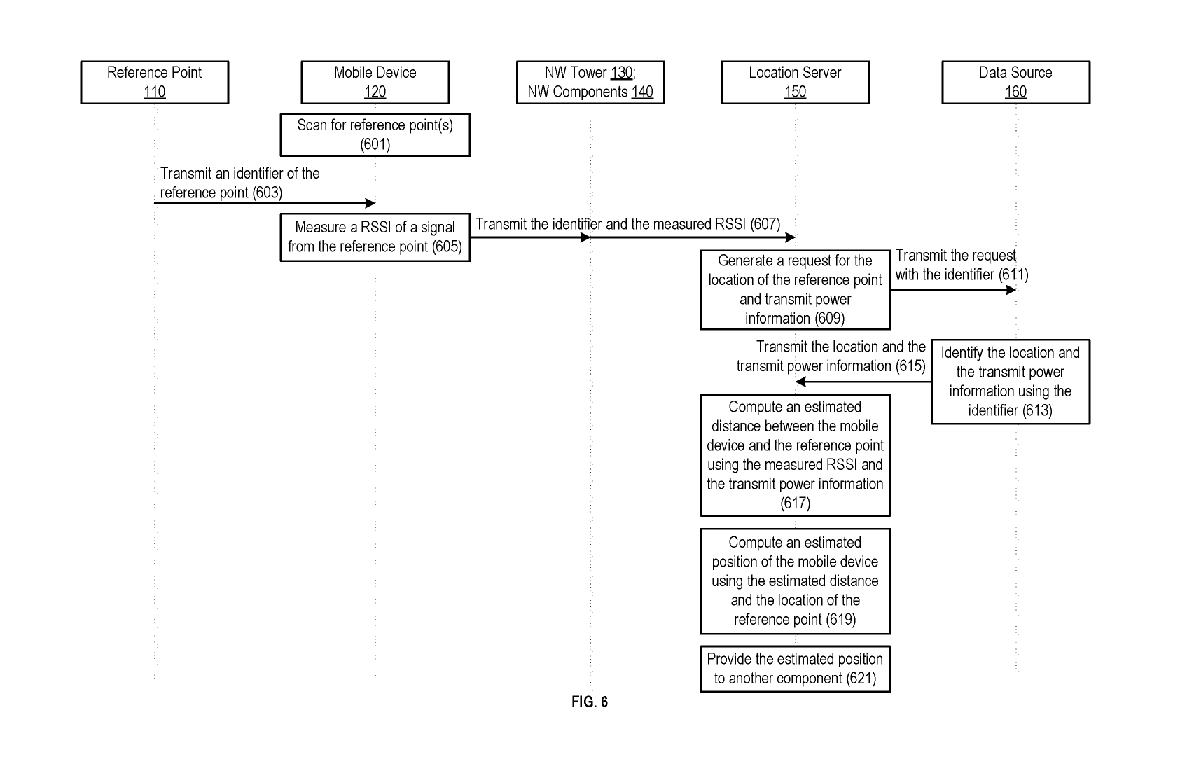

The data source 160 also stores the transmission power information for the reference point 110 for future use (step 416b). One approach for using the stored transmission power information is described later with reference to FIG. 6.

The location server 150 computes an estimated distance between the reference point 110 and an unknown position of the mobile device 120 using the measured RSSI and the transmission power information (step 417b). The approaches for computing an estimated distance between the reference point 110 and an unknown position of the mobile device 120 that were described for step 417a of FIG. 4A may be used during step 417b.

The location server 150 uses known techniques to estimate a position of the mobile device 120 using the estimated distance and the location of the reference point 110 (step 419b), and the location server 150 provides the estimated position to the mobile device 120, a Public Safety Access Point (“PSAP”), or other component (step 421b). The approaches for computing an estimated position of the mobile device 120 that were described for step 219 of FIG. 2 may be used during step 419b. In some embodiments, the steps prior to step 419b of FIG. 4B may be repeated for additional reference points before the estimated position is computed using estimated distances between the mobile device 120 and each of the additional reference points.

### Embodiments for Using Transmission Power Information to Compute an Estimated Distance Between a Mobile Device and Reference Point for Use in Computing an Estimated Position of a Mobile Device

A process for using transmission power information received by a mobile device from a reference point to compute an estimated distance between the mobile device and the reference point, and for communicating the estimated distance for use by a location server in computing an estimated position of the mobile device is depicted in FIG. 4C.

As shown in FIG. 4C, the mobile device 120 scans for one or more available reference points (step 401c). The mobile device 120 receives an identifier of a reference point 110 from signaling received by the mobile device 120 from the reference point 110 (step 403c). The mobile device 120 also receives transmission power information from the reference point 110 (step 403c), and the mobile device 120 measures a RSSI of a signal received from the reference point 110 (step 405c).

The mobile device 120 computes an estimated distance between the reference point 110 and an unknown position of the mobile device 120 using the measured RSSI and the transmission power information (step 406c). The approaches for computing an estimated distance between the reference point 110 and an unknown position of the mobile device 120 that were described for step 417a of FIG. 4A may be used during step 406c.

The mobile device 120 transmits the identifier of the reference point 110, the estimated distance, and optionally the measured RSSI to the location server 150 (step 407c).

The location server 150 generates a request for the location of the reference point 110 (step 409c), and transmits the request with the identifier to the data source 160 (step 411c). The data source 160 uses the identifier of the reference point 110 to identify a stored location of the reference point 110 (step 413c), and transmits the stored location of the reference point 110 to the location server 150 (step 415c).

The location server 150 uses known techniques to estimate a position of the mobile device 120 using the estimated distance and the location of the reference point 110 (step 419c), and the location server 150 provides the estimated position to the mobile device 120, a Public Safety Access Point (“PSAP”), or other component (step 421c). The approaches for computing an estimated position of the mobile device 120 that were described for step 219 of FIG. 2 may be used during step 419c. In some embodiments, the steps prior to step 419c of FIG. 4C may be repeated for additional reference points before the estimated position is computed using estimated distances between the mobile device 120 and each of the additional reference points.

### Embodiments for Using Transmission Power Information to Modify a Measured RSSI of a Signal Received by a Mobile Device for Use in Computing an Estimated Position of a Mobile Device

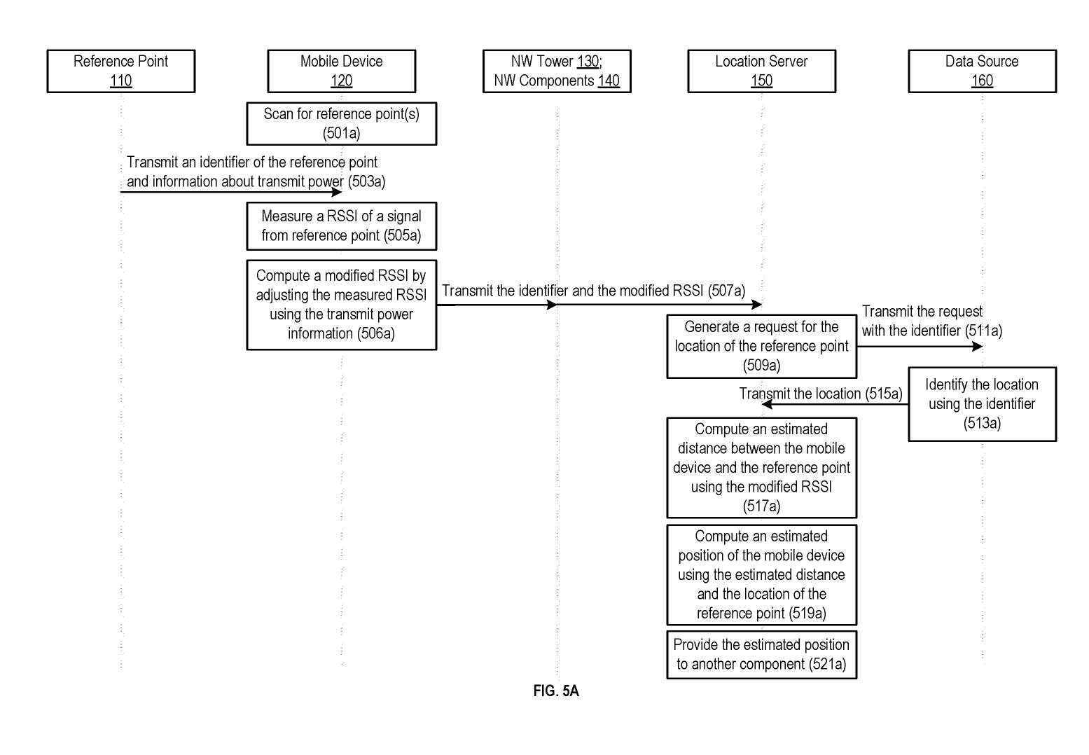

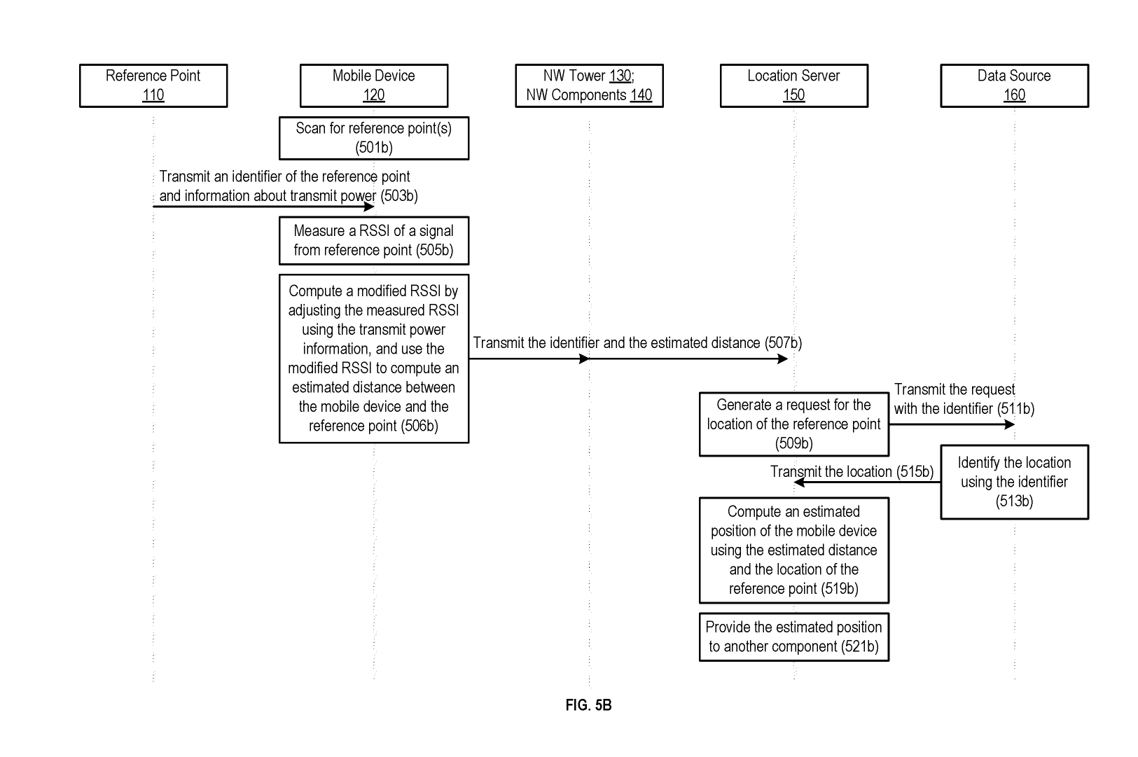

A process for using transmission power information received by a mobile device from a reference point to modify a measured RSSI of a signal received by the mobile device from the reference point, and for communicating the modified RSSI for use by a location server in computing an estimated position of the mobile device is depicted in FIG. 5A.

As shown in FIG. 5A, the mobile device 120 scans for one or more available reference points (step 501a). The mobile device 120 receives an identifier of a reference point 110 from signaling received by the mobile device 120 from the reference point 110 (step 503a). The mobile device 120 also receives transmission power information from the reference point 110 (step 503a). The mobile device 120 measures a RSSI of a signal received from the reference point 110 (step 505a).

The mobile device 120 computes a modified RSSI using the transmission power information to adjust the measured RSSI (step 506a). By way of example, the measured RSSI (RSSI_{measured}) may be adjusted by an RSSI adjustment (RSSI_{adjustment}) to result in the modified RSSI (RSSI_{modified}) as follows:

RSSI_{modified}=RSSI_{measured} +RSSI_{adjustment} (Equation 3),

where the units are in dBm or other suitable units.

In some embodiments, the RSSI adjustment may simply be a positive or negative value of the transmission power information (e.g., a Reference RSSI for a Bluetooth beacon, or a Transmit Power Used for a Wi-Fi access point).

In other embodiments, the RSSI adjustment may be another value that is computed using the transmission power information. The other value could be a value that modifies the measured RSSI in such a way that the measured RSSI is normalized to what the measured RSSI would have been if the signal from the reference point 110 was transmitted at a normalized (e.g., agreed upon) transmission power level. By way of example, the RSSI adjustment (RSSI_{adjustment}) may be a difference between a normalized transmission power level (Tx_Pwr_{mormalized}) and the transmission power information received from the reference location 110 (Tx_Pwr_Info). In one implementation, the modified RSSI (RSSI_{modified}) may be computed as follows:

RSSI_{modified}=RSSI_{measured}+(tx_Pwr_{normalized}−tx_Pwr_Info) Equation 4),

where the units are in dBm or other suitable units.

By way of example, a Bluetooth beacon's transmission power information is a Reference RSSI that is a measurement of RSSI made by the manufacturer of that beacon at a distance of 1 meter from that beacon. The Reference RSSI can be made available to mobile devices via signaling from that beacon. The normalized transmission power level for that beacon (and other beacons) could be an agreed upon value of RSSI at 1 meter. Thus, the modified RSSI (RSSI_{modified}) for a Bluetooth beacon may be computed using the Reference RSSI (Ref_RSSI) and the agreed upon value of RSSI (RSSI_{normalized}) as follows:

RSSI_{modified}=RSSI_{measured}+(RSSI_{normalized} −Ref_RSSI) (Equation 5),

where the units are in dBm or other suitable units.

A similar approach may be followed for a Wi-Fi access point, transmission power information of that access point (e.g., a Transmit Power Used), and a normalized transmission power level. Thus, the modified RSSI (RSSI_{modified} ) for a Wi-Fi access point may be computed using the Transmit Power Used (Tx_Pwr_Used) and the agreed upon normalized transmission power level (Tx_Pwr_Used_{normalized}) as follows:

RSSI_{modified}=RSSI_{measured}+(Tx_Pwr_Used_{normalized}−Tx_Pwr_Used) (Equation 6),

where the units are in dBm or other suitable units.

The mobile device 120 transmits the identifier of the reference point 110 and the modified RSSI to the location server 150 (step 507a). In an alternative embodiment of step 507a, where transmission power information is not received during step 503a or where the mobile device 120 is a legacy mobile device that is not configured to compute the modified RSSI, the modified RSSI is not computed during step 506a, and the measured RSSI is sent to the network during step 507a. In one implementation of this alternative embodiment, the mobile device also transmits an indication that the RSSI being transmitted is not a modified RSSI, and is instead the measured RSSI. The indication may take different forms in different embodiments. In one embodiment, the indication is a flag (e.g., one or more bits). In another embodiment, the indication includes fields allocated for the modified RSSI that are set to predefined values (e.g., zeros, ones, or other values).

The location server 150 generates a request for the location of the reference point 110 (step 509a), and transmits the request with the identifier to the data source 160 (step 511a). The data source 160 uses the identifier of the reference point 110 to identify a stored location of the reference point 110 (step 513a), and transmits the stored location of the reference point 110 to the location server 150 (step 515a).

The location server 150 computes an estimated distance between the reference point 110 and an unknown position of the mobile device 120 using the modified RSSI (RSSI_{modified}) and the normalized transmission power level (Tx_Pwr_{normalized}) (step 517a). By way of example, the estimated distance d (e.g., in meters) may be computed using Equation 7A below:

d=10̂[(Tx_Pwr_{normalized}−RSSI_{modified})/10n ] (Equation 7A),

where Tx_Pwr_{normalized} is the normalized transmission power level, RSSI_{modified} is the modified RSSI, and n is typically between 2 and n=5, depending on the expected propagation environment. Alternatively, the estimated distance d may be computed using Equation 7B below:

$$d = \frac{c \times \sqrt{P - S}}{4 \times π \times f} , \qquad ( Equation 7 B )$$

where P is the normalized transmission power level, S is the modified RSSI, and the remaining terms are the same as Equation 1. Other equations may be used depending on the environment of deployment.

The location server 150 uses known techniques to estimate a position of the mobile device 120 using the estimated distance and the location of the reference point 110 (step 519a), and the location server 150 provides the estimated position to the mobile device 120, a Public Safety Access Point (“PSAP”), or other component (step 521a). The approaches for computing an estimated position of the mobile device 120 that were described for step 219 of FIG. 2 may be used during step 519a. In some embodiments, the steps prior to step 519a of FIG. 5A may be repeated for additional reference points before the estimated position is computed using estimated distances between the mobile device 120 and each of the additional reference points.

Of course, computation of a distance between the reference point 110 and an unknown position of the mobile device 120 is not required to estimate the unknown position of the mobile device 120. Instead, the estimated position may be set to a position of the closest reference point 110 relative to the unknown position of the mobile device 120, where the closest reference point 110 is assumed to have transmitted a signal 113 that resulted in the highest modified RSSI.

### Embodiments for Using Transmission Power Information to Modify a Measured RSSI, and Using the Modified RSSI to Compute an Estimated Distance Between a Mobile Device and Reference Point for Use in Computing an Estimated Position of a Mobile Device

A process for using transmission power information received by a mobile device from a reference point to modify a measured RSSI of a signal received by the mobile device from the reference point, for using the modified RSSI to compute an estimated distance between the mobile device and the reference point, and for communicating the estimated distance to a location server for use in computing an estimated position of the mobile device is depicted in FIG. 5B.

As shown in FIG. 5B, the mobile device 120 scans for one or more available reference points (step 501b). The mobile device 120 receives an identifier of a reference point 110 from signaling received by the mobile device 120 from the reference point 110 (step 503b). The mobile device 120 also receives transmission power information from the reference point 110 (step 503b), and the mobile device 120 measures a RSSI of a signal received from the reference point 110 (step 505b).

The mobile device 120 computes a modified RSSI using the transmission power information to adjust the measured RSSI (step 506b). The approaches for computing a modified RSSI that were described for step 506a of FIG. 5A may be used during step 506b.

The mobile device 120 also computes an estimated distance between the reference point 110 and an unknown position of the mobile device 120 using the modified RSSI (step 506b). The approaches for computing an estimated distance between the reference point 110 and an unknown position of the mobile device 120 that were described for step 517a of FIG. 5A may be used during step 506b.

The mobile device 120 transmits the identifier of the reference point 110 and the estimated distance to the location server 150 (step 507b).

The location server 150 generates a request for the location of the reference point 110 (step 509b), and transmits the request with the identifier to the data source 160 (step 511b). The data source 160 uses the identifier of the reference point 110 to identify a stored location of the reference point 110 (step 513b), and transmits the stored location of the reference point 110 to the location server 150 (step 515b).

The location server 150 uses known techniques to estimate a position of the mobile device 120 using the estimated distance and the location of the reference point 110 (step 519b), and the location server 150 provides the estimated position to the mobile device 120, a Public Safety Access Point (“PSAP”), or other component (step 521b). The approaches for computing an estimated position of the mobile device 120 that were described for step 219 of FIG. 2 may be used during step 519b. In some embodiments, the steps prior to step 519b of FIG. 5B may be repeated for additional reference points before the estimated position is computed using estimated distances between the mobile device 120 and each of the additional reference points.

### Embodiments for Retrieving Stored Transmission Power Information for Use in Computing an Estimated Position of a Mobile Device

A process for retrieving stored transmission power information relating to a reference point that transmitted a signal to a mobile device for use by a location server in computing an estimated position of the mobile device is depicted in FIG. 6.

As shown in FIG. 6, the mobile device 120 scans for one or more available reference points (step 601). The mobile device 120 receives an identifier of a reference point 110 from signaling received by the mobile device 120 from the reference point 110 (step 603). The mobile device 120 measures a RSSI of a signal received from the reference point 110 (step 605), and transmits the identifier of the reference point 110 and the measured RSSI to the location server 150 (step 607). The location server 150 generates a request for the location of the reference point 110 (step 609), and transmits the request with the identifier to the data source 160 (step 611).

The location server 150 also generates a request for transmission power information of the reference point 110 (step 609), and transmits the request for the transmission power information to the data source 160 (step 611).

The data source 160 uses the identifier of the reference point 110 to identify a stored location of the reference point 110 that is associated with the identifier (e.g., via look up using the identifier) (step 613), and transmits the stored location of the reference point 110 to the location server 150 (step 615).

The data source 160 also identifies transmission power information of the reference point 110 that is associated with the identifier (e.g., via look up using the identifier) (step 613), and transmits the stored transmission power information of the reference point 110 to the location server 150 (step 615). Transmission of the stored transmission power information from the data source 160 to the location server 150 may be carried out by adding a field to the message from the data source 160 to the location server 150 that contains the transmission power information.

The location server 150 computes an estimated distance between the reference point 110 and an unknown position of the mobile device 120 using the measured RSSI and the transmission power information (step 617). The approaches for computing an estimated distance between the reference point 110 and an unknown position of the mobile device 120 that were described for step 417a of FIG. 4A may be used during step 617.

The location server 150 uses known techniques to estimate a position of the mobile device 120 using the estimated distance and the location of the reference point 110 (step 619b), and the location server 150 provides the estimated position to the mobile device 120, a Public Safety Access Point (“PSAP”), or other component (step 621). The approaches for computing an estimated position of the mobile device 120 that were described for step 219 of FIG. 2 may be used during step 619. In some embodiments, the steps prior to step 619 of FIG. 6 may be repeated for additional reference points before the estimated position is computed using estimated distances between the mobile device 120 and each of the additional reference points.

### Signaling

As mentioned above, new information elements are needed to transmit certain data from the mobile device 120 to the location server 150. By way of example, such data may include (i) transmit power information that was received by the mobile device 120 from a reference point 110, (ii) an indication that transmit power information is not being transmitted from the mobile device 120 to the location server 150, (iii) an estimated distance between an unknown position of the mobile device 120 and a reference point 110 that the mobile device 120 computed using transmit power information, (iv) a modified RSSI that the mobile device 120 computed using transmit power information, and/or (v) an indication that a modified RSSI is not being transmitted from the mobile device 120 to the location server 150.

For embodiments that use Bluetooth beacons as reference points, a new information element is added to LPP and LPPe, or an existing information element associated with a Bluetooth beacon is modified in LPP and LPPe, to specify a field for (i) the Reference RSSI or other transmission power information, (ii) the indication that the Reference RSSI or other transmission power information is not being transmitted, (iii) the estimated distance, (iv) the modified RSSI, and/or (v) the indication that the modified RSSI is not being transmitted.

For embodiments that use Wi-Fi access points as reference points, a new information element is added to LPP or LPPe, or an existing information element associated with a Wi-Fi reference point is modified in LPP or LPPe, to specify a field for (i) the Transmit Power Used or other transmission power information, (ii) the indication that the Transmit Power Used or other transmission power information is not being transmitted, (iii) the estimated distance, (iv) the modified RSSI, and/or (v) the indication that the modified RSSI is not being transmitted.

Examples of each new information element (IE) for LPP or LPPe are provided below, where n is the 3GPP or OMA released number:

| Bluetooth Data | Information Element (IE) |
|---|---|
| Transmission power | btTxPower-rn (e.g., integers (−20 to 10) or integers (−128 to 127), |
| information | or other values indicating the transmission power information in |
| | dBm) |
| Reference RSSI | btReferenceRssi-rn (e.g., integers (−128 to 127), or other values |
| | indicating the Reference RSSI in dBm as measured from x units |
| | of measurement away from the Bluetooth beacon) [note: the |
| | Reference RSSI IE may be used instead of the transmission |
| | power information IE to designate the Reference RSSI when the |
| | Reference RSSI is used as transmission power information] |
| Transmission power | Option 1: btTxPowerFlag-rn (e.g., integers (0 or 1), or other |
| information not | values indicating transmission power information is not being |
| transmitted | transmitted) |
| | Option 2: btTxPower-rn with predefined value(s) |
| Reference RSSI is not | Option 1: btReferenceRssiFlag-rn (e.g., integers (0 or 1), or |
| transmitted | other values indicating Reference RSSI is not being transmitted) |
| | Option 2: btReferenceRssi-rn with predefined value(s) |
| Estimated distance | btEstimatedDistance-rn (e.g., integers (0 to 300), or other values |
| | indicating the estimated distances in units of measurement, such |
| | as meters or other units) |
| Modified RSSI | btModifiedRssi-rn (e.g., integers (−128 to 127), or other values |
| | indicating the modified RSSI in dBm) |
| Modified RSSI not | Option 1: btModifiedRssiFlag-rn (e.g., integers (0 or 1), or other |
| transmitted | values indicating a modified RSSI is not being transmitted) |
| | Option 2: btModifiedRssi-rn with predefined value(s) |

Similar IEs may be used for Wi-Fi data, or for data of other reference points, where the “bt” is replaced with “wlan”, “ap” or another another designator (e.g., “rp” for reference point, or other).

### Other Aspects

Methods of this disclosure may be implemented by hardware, firmware or software. One or more non-transitory machine-readable media embodying program instructions that, when executed by one or more machines, cause the one or more machines to perform or implement operations comprising the steps of any of the described methods are also contemplated. As used herein, machine-readable media includes all forms of statutory machine-readable media (e.g. statutory non-volatile or volatile storage media, statutory removable or non-removable media, statutory integrated circuit media, statutory magnetic storage media, statutory optical storage media, or any other statutory storage medic). As used herein, machine-readable media does not include non-statutory media. By way of example, machines may include one or more computing device(s), processor(s), controller(s), integrated circuit(s), chip(s), system(s) on a chip, server(s), programmable logic device(s), other circuitry, and/or other suitable means described herein or otherwise known in the art.

Method steps described herein may be order independent, and can therefore be performed in an order different from that described. It is also noted that different method steps described herein can be combined to form any number of methods, as would be understood by one of skill in the art. It is further noted that any two or more steps described herein may be performed at the same time. Any method step or feature disclosed herein may be expressly restricted from a claim for various reasons like achieving reduced manufacturing costs, lower power consumption, and increased processing efficiency. Method steps performed by a mobile device can be performed by a server, or vice versa.

In some embodiments, any activities at the location server 150 shown in the figures (e.g., computations, generation and transmission of requests, and other functions) can instead occur at the mobile device 120. Such circumstances may occur when the location server 150 is not used to compute the estimated position of the mobile device 120.

Systems comprising one or more modules that perform, are operable to perform, or adapted to perform different method steps/stages disclosed herein are also contemplated, where the modules are implemented using one or more machines listed herein or other suitable hardware. When two things (e.g., modules or other features) are “coupled to” each other, those two things may be directly connected together (e.g., shown by a line connecting the two things in the drawings), or separated by one or more intervening things. Where no lines and intervening things connect two particular things, coupling of those things is contemplated unless otherwise stated. Where an output of one thing and an input of another thing are coupled to each other, information (e.g., data and/or signaling) sent from the output is received by the input even if the data passes through one or more intermediate things. All information disclosed herein may be transmitted over any communication pathway using any protocol. Data, instructions, commands, information, signals, bits, symbols, and chips and the like may be represented by voltages, currents, electromagnetic waves, magnetic fields or particles, or optical fields or particles.

The words comprise, comprising, include, including and the like are to be construed in an inclusive sense (i.e., not limited to) as opposed to an exclusive sense (i.e., consisting only of). Words using the singular or plural number also include the plural or singular number, respectively. The word or and the word and, as used in the Detailed Description, cover any of the items and all of the items in a list. The words some, any and at least one refer to one or more. The term may is used herein to indicate an example, not a requirement—e.g., a thing that may perform an operation or may have a characteristic need not perform that operation or have that characteristic in each embodiment, but that thing performs that operation or has that characteristic in at least one embodiment.

The mobile device 120 may be in the form of a computing device (e.g., a mobile phone, tablet, laptop, digital camera, tracking tag, receiver), and may include any of: antenna module(s) for exchanging signals with other systems; RF front end module(s) with circuitry components that are known or disclosed herein; processing module(s) for signal processing of received signals to determine position information (e.g., times of arrival or travel time of received signals, atmospheric information from transmitters, and/or location or other information associated with each transmitter), for using the position information to compute an estimated position of the mobile device, for performing methods described herein, and/or for performing other processing; memory module(s) for providing storage and retrieval of data and/or instructions relating to methods of operation described herein that may be executed by the processing module(s) or other module(s); sensor module(s) for measuring environmental conditions at or near the mobile device (e.g., pressure, temperature, humidity, wind, other), which may be compared to the same environmental conditions at or near transmitters to determine the altitude of the mobile device; other sensor module(s) for measuring other conditions (e.g., acceleration, velocity, orientation, light, sound); interface module(s) for exchanging information with other systems via other links other than a radio link; and/or input/output module(s) for permitting a user to interact with the mobile device.

The term “transmit power” used herein is synonymous with the term “transmission power”.

Other known measures of signal strength may alternatively be used in place of RSSI in alternative implementations of embodiments described herein that use RSSI.

1. A method for communicating data to a location server for use by the location server in estimating a position of a mobile device, the method comprising:
receiving, from the mobile device, an identifier of a reference point that transmitted a signal that was received by the mobile device; and
receiving, from the mobile device, (i) transmission power information of the reference point or (ii) an estimate of a distance separating the mobile device and the reference point.

2. The method of claim 1, wherein receiving (i) the transmission power information of the reference point or (ii) the estimate of the distance separating the mobile device and the reference point comprises: receiving the transmission power information of the reference point.

3. The method of claim 2, wherein the reference point is a Bluetooth beacon, and the transmission power information specifies a Reference RSSI.

4. The method of claim 2, wherein the method further comprises:
receiving, from the mobile device, a measured amount of power present in the signal the mobile device received from the reference point.

5. The method of claim 4, wherein the method comprises:
estimating, at the location server, the distance separating the mobile device and the reference point using the transmission power information and the measured amount of power;
identifying a location of the reference point using the identifier of the reference point; and
computing, at the location server, an estimated position of the mobile device using the estimated distance and the location of the reference point.

6. The method of claim 2, wherein the method comprises:
storing, at a data source, the transmission power information that was transmitted by the mobile device to the location server.

7. The method of claim 6, wherein the method comprises:
receiving, from another mobile device, a measured amount of power present in another signal received by the other mobile device from the reference point;
receiving, from the data source, the stored transmission power information;
estimating, at the location server, a distance separating the other mobile device and the reference point using the stored transmission power information and the measured amount of power present in the other signal; and
computing, at the location server, an estimated position of the other mobile device using the location of the reference point and the estimated distance separating the other mobile device and the reference point.

8. The method of claim 1, wherein receiving (i) the transmission power information or (ii) an estimate of a distance separating the mobile device and the reference point comprises:
receiving, from the mobile device, the estimate of the distance separating the mobile device and the reference point, wherein the estimate of the distance was computed by the mobile device using the transmission power information and a measured amount of power present in a signal the mobile device received from the reference point.

9. The method of claim 8, wherein the method comprises:
identifying a location of the reference point using the identifier of the reference point;
computing, at the location server, an estimated position of the mobile device using the estimate of the distance and the location of the reference point.

10. The method of claim 2, wherein the transmission power information is received using a LPP or LPPe protocol.

11. The method of claim 8, wherein the estimate of the distance is received using a LPP or LPPe protocol.

12. The method of claim 2, wherein the transmission power information is received using one or more information elements that are configured to communicate the transmission power information.

13. The method of claim 8, wherein the estimate of the distance is received using one or more information elements that are configured to communicate the estimate of the distance.

14. The method of claim 1, wherein the method comprises:
receiving, from another mobile device, another identifier of another reference point; and
receiving, from the other mobile device, an indication that transmission power information specifying the transmission power used by the other reference point is not available. The indication could be the absence of an optional transmission power field.

15. The method of claim 5, wherein the reference point is a Bluetooth beacon, and the transmission power information specifies is a Reference RSSI of the Bluetooth beacon.

16. The method of claim 5, wherein the reference point is a Wi-Fi access point, and the transmission power information specifies is a transmission power used by the Wi-Fi access point.

17. One or more non-transitory machine-readable media embodying program instructions that, when executed by one or more machines, cause the one or more machines to implement a method for communicating data to a location server for use by the location server in estimating a position of a mobile device, the method comprising:
receiving, from the mobile device, an identifier of a reference point that transmitted a signal that was received by the mobile device; and
receiving, from the mobile device, (i) transmission power information of the reference point or (ii) an estimate of a distance separating the mobile device and the reference point.

18. A system for communicating data to a location server for use by the location server in estimating a position of a mobile device, the system comprising:
a location server that is operable to:
receive, from the mobile device, an identifier of a reference point that transmitted a signal that was received by the mobile device; and
receive, from the mobile device, (i) transmission power information of the reference point or (ii) an estimate of a distance separating the mobile device and the reference point.

19. The system of claim 18, wherein the location server is operable to:
receive the transmission power information;
receive a measured amount of power present in the signal the mobile device received from the reference point;
estimate the distance separating the mobile device and the reference point using the transmission power information and the measured amount of power identify a location of the reference point using the identifier of the reference point; and
compute an estimated position of the mobile device using the estimated distance and the location of the reference point.

20. The system of claim 18, wherein the location server is operable to:
receive, from the mobile device, the estimate of the distance separating the mobile device and the reference point,
wherein the estimate of the distance was computed by the mobile device using the transmission power information and a measured amount of power present in a signal the mobile device received from the reference point;
identify a location of the reference point using the identifier of the reference point; and
compute an estimated position of the mobile device using the estimate of the distance and the location of the reference point.
